(19) United States
(12) Patent Application Publication
(10) Pub. No.: US 2021/0142248 A1
(43) Pub. Date: May 13, 2021

(54) MIXED VEHICLE SELECTION AND ROUTE OPTIMIZATION

(71) Applicant: Ford Global Technologies, LLC, Dearborn, MI (US)

(72) Inventor: Alexander BALVA, Palo Alto, CA (US)

(21) Appl. No.: 17/047,431

(22) PCT Filed: Apr. 18, 2018
(86) PCT No.: PCT/US2018/028124

§ 371 Date: Oct. 14, 2020

(51) Int. Cl. G06Q 10/06; G06Q 10/04; G08G 1/00

(52) U.S. Cl. CPC G06Q 10/06315; G06Q 50/30; G08G 1/202; G06Q 10/047

(57) ABSTRACT

Various embodiments provide approaches for selecting vehicles and optimizing routes for a combination of passenger transportation requests and cargo delivery requests. The passenger transportation requests can relate to the transportation of people (i.e., passengers) and the cargo delivery request can related to the delivery of animals, packages, or other objects, from an origination location to a destination location. There may be several different types of vehicles available, each of which may be particularly advantageous (e.g., efficient) for a certain type of route, including passenger-only vehicles which are only used to serve passenger requests, cargo-only vehicles which are only used to serve cargo delivery requests, and mixed passenger and cargo vehicles which can be used to serve both passenger requests and cargo requests. In some embodiments, the mixed passenger and cargo vehicles may hold passengers and cargo at the same time, servicing both types of requests simultaneously.

### BACKGROUND

People are increasingly turning to offerings such as ridesharing to accomplish everyday tasks. Ridesharing can involve riders being allocated vehicles that are dedicated to those riders for a period of time, or being allocated seats on vehicles that will have other passengers riding at the same time. While individually allocated cars can have some benefits, sharing vehicles can reduce cost and provide some certainty as to scheduling. In order to ensure profitability of such a service, it is often desirable to attempt to minimize cost, as well as to increase utilization of the vehicles. Additionally, such techniques may similarly be used to delivery packages or other goods. When determining a vehicle to assign for a particular ride or delivery, conventional approaches look to the vehicles that are available at that time. Such an approach can be less than optimal, however, as the available vehicles may be a significant distance away, which increases the cost of providing that particular ride or route due to the extra costs of getting the vehicle to the origination location. Further, this extra distance can delay the start time of the ride or delivery, which not only impacts the user experience but also decreases the utilization of that vehicle.

### BRIEF DESCRIPTION OF THE DRAWINGS

Various embodiments in accordance with the present disclosure will be described with reference to the drawings, in which:

FIG. 1 illustrates an example ride request environment in which various embodiments can be implemented.

FIGS. 2A and 2B illustrate example origination and destination locations, and routes for serving those locations, that can be determined for a service area over a period of time in accordance with various embodiments.

FIG. 3 illustrates example service metrics that can be balanced via an objective function in accordance with various embodiments.

FIG. 4 illustrates an example system that can be utilized to implement aspects of the various embodiments.

FIG. 5 illustrates another example system that can be utilized to implement aspects of the various embodiments.

FIG. 6 illustrates an example process for determining a routing solution for a set of trip requests that can be utilized in accordance with various embodiments.

FIG. 7 illustrates an example process for optimizing proposed routing solutions that can be utilized in accordance with various embodiments.

FIG. 8 illustrates an example computing device that can be utilized to submit trip requests and receive route options in accordance with various embodiments.

FIG. 9 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the providing of transportation in response to various requests. In particular, various embodiments provide approaches for selecting vehicles and optimizing routes for a combination of passenger transportation requests and cargo delivery requests. The passenger transportation requests can relate to the transportation of people (i.e., passengers) and the cargo delivery request can related to the delivery of animals, packages, or other objects, from an origination location to a destination location. There may also be sub-categories of requests that may have different restrictions or requirements, as may include transportation for individuals, riders associated with private companies or entities, as well as transportation paid for by a public entity, such as a local transportation authority. The sub-categories can also include differences for packages or transport, where a general category might include general capacity for boxes and conventional packages, while other types of cargo may relate to live animals, plants, or other types of items that may require special types of capacity. The various ride requests received may also include at least one time component, among other such options. There may be several different types of vehicles available at different times, each of which may be particularly advantageous (e.g., efficient) for a certain type of route and/or for certain types of riders or cargo.

As discussed in more detail elsewhere herein, approaches in accordance with various embodiments can also prevent reduplication of rides and ride options. In many embodiments, there will be a variety of options available for presentation to the user but limited space in which to present those options. Accordingly, one or more similarity or diversity criteria can be used to ensure that the ride options presented to the user provide sufficient diversity and are not substantially duplicates of other presented ride options. In some embodiments, this can include providing options that were determined using different optimization criteria or weightings. For example, one option might be optimized for cost, one for price, and one for quality of service. Even using such different criteria, the options may be processed with a diversity manager to ensure that the ride options provided satisfy at least one diversity criterion, such as having at least a minimum difference in route taken, time, cost, quality, or other such metrics. In some embodiments the options can be processed using a diversity functions and then ranked by a diversity score, with at least a subset of the highest ranked options being provided to the user. In at least some embodiments the diversity function can utilize weightings that are personalized for the user, based at least in part upon factors that have been determined to be of importance to the user based on past selections, such as where the user has selected ride options optimized for length or price, etc.

A provider, such as a transportation service, can utilize various factors to plan optimized routes and select the type of vehicle for a certain route, given a finite number of each type of vehicle. For example, the provider may utilize an objective function to balance various metrics when selecting between proposed routes and vehicle selections. An objective function can provide a compromise between, for example, rider/customer experience and provider economics, taking into account metrics such as rider convenience, on-time delivery, rider comfort, operational efficiency, and the ability to service confirmed trips. The analysis can consider not only planned trips, or trips currently being planned, but also trips currently in progress. One or more optimization processes can be applied, which can vary the component values or weightings of the objective function in order to attempt to improve the quality score generated for each proposed routing solution.

In various embodiments, historical route data can be used to estimate future demand, which can be used for route optimization and vehicle selection. Specifically, historical route data for a plurality of previously-requested routes may be collected, in which each previously-requested route is either a passenger request or a cargo request, and associated with an origin, a destination, and a time. Thus, future demand involving passenger requests and cargo requests can be predicted using the historical route data. In some embodiments, a set of proactive passenger requests and cargo requests corresponding to the predicted demand may be generated and submitted to a simulation module of a vehicle selection route determination system, which can determine a set of routes for a future period of time and assign the routes to vehicles of the transportation service. The vehicles may include different types of vehicles, including passenger-only vehicles which are only used to serve passenger requests, cargo-only vehicles which are only used to serve cargo delivery requests, and mixed passenger and cargo vehicles which can be used to serve both passenger requests and cargo requests. In some embodiments, the mixed passenger and cargo vehicles may hold passengers and cargo at the same time, servicing both types of requests simultaneously. In some embodiments, the determined routes are sent to the respectively assigned vehicles or computing devices onboard or associated with the vehicles. The routes may be sent as a part of computer-readable instructions.

Various other such functions can be used as well within the scope of the various embodiments as would be apparent to one of ordinary skill in the art in light of the teachings and suggestions contained herein.

FIG. 1 illustrates an example environment 100 in which aspects of the various embodiments can be implemented. In this example, a user can request transportation from an origination to a destination location using, for example, an application executing on a client computing device 110. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 100 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. A request may also be made for the delivery of a package, letter, parcel, or other type of cargo from an origination to a destination. In some embodiments, one or more deliveries may be scheduled without user explicitly making requests. For example, a plurality of packages may be received to a warehouse or shipment receiving facility and need to be delivered to their final destinations.

In this example, a rideshare service offers routes using at least one type of vehicle that includes space for a driver 102 and seats or other capacity. Various types of vehicles with different amounts or configurations of capacity may be available and can be selected for routes accordingly. Additionally, autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 106 (or other capacity) may be occupied by riders or cargo, while another number of seats 108 may be unoccupied. In order to improve the economics of the rides offered, it can be desirable in at least some embodiments to have the occupancy as close to full as possible during the entire length of the trip. Such a situation results in very few unsold capacity, which improves operational efficiency. One way to achieve high occupancy might be to offer only fixed routes where all passengers board at a fixed origination location and off-board at a fixed destination location, with no passengers onboarding or off-boarding at intermediate locations.

In the present example, a given user can enter an origination location 112 and a destination location 114, either manually or from a set of suggested locations 116, among other such options, such as by selecting from a map 118 or other interface element. In other embodiments, source such as a machine learning algorithm or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

FIGS. 2A and 2B illustrate one example approach that can be utilized to provide such service in accordance with various embodiments. In the example mapping 200 of FIG. 2A, a set of origination points 202 and destination points 204 indicate locations, over a determined period of time, between which one or more users would like to travel or between the pick-up and drop-off locations for cargo. As illustrated, there may be clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

In various embodiments, the transportation of cargo can exhibit a variety of patterns as well. In some embodiments, cargo may all originate from one or a few central distribution centers, such as a post office, a store, an office or warehouse, and the like, and be delivered to the same for different destinations. For example, a large amount of cargo, such as office supplies is to be delivered from a warehouse to an office. In another example, cargo may originate from a post office and be delivered to a plurality of individual residences, requiring multiple stops. In some embodiments, cargo may originate from different origination locations and be delivered to the same destination. For example, it may be the case that packages are picked-up from a plurality of different residences and all are to be delivered to the post office or other shipping facility. In some embodiments, cargo may have different origination locations as well as different destinations locations. For example, packages can be picked-up and dropped-off at different locations along a route, such as for individual local deliveries like food deliveries between restaurants and residences. In various embodiments, and as mentioned, a route may be most optimized when a vehicle carries both passengers and cargos simultaneously.

It thus can be desirable, in at least some embodiments, to provide routes and transportation options that balance, or at least take into consideration, the above and other such factors. As an example, the mapping 250 of FIG. 2B illustrates a selection of routes 252 that can be provided over a period of time in order to satisfy various passenger and/or cargo transport. The routes may not include or correspond to each precise origination and destination location, but can come within an acceptable distance of those locations in most instances. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 252 provided by such a service may change over time, or even at different times of day, but can be sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the type of vehicles to use to provide those routes, various factors can be considered as discussed and suggested herein. In some embodiments, there may be different types of vehicles, including passenger-only vehicles which are only used to serve passenger requests, cargo-only vehicles which are only used to serve cargo delivery requests, and mixed passenger and cargo vehicles which can be used to serve both passenger requests and cargo requests. In some embodiments, the mixed passenger and cargo vehicles may hold passengers and cargo at the same time, servicing both types of requests simultaneously. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

As mentioned, there may be other factors relating to mixed-use mobility service offerings that can be considered within the scope of the various embodiments. For example, a private company or enterprise might purchase capacity with certain requirements, such as a minimum amount of capacity on a vehicle, a certain type of seating, certain types of vehicles, etc. Similar types of requirements or restrictions might be used for rides purchased by a public entity, although the values or types of requirements or restrictions may be drastically different. The requirements for different types of riders can be considered when selecting an optimizing the various ride offerings. In some embodiments there may be different vehicles or configurations used for different types or categories of riders, while in other embodiments a given vehicle might have different seating areas or sections for different types of riders based at least in part upon the requirements or restrictions. In some instances riders for a given entity might be given priority for a corresponding section of a vehicle. There may also be different quality of service targets or agreements for the different categories of riders. Similar differences can be taken into account for cargo or other objects being transported as discussed elsewhere herein.

Approaches in accordance with various embodiments can utilize at least one objective function to determine route options, and the type of vehicle for respective routes, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

FIG. 3 illustrates an example set of service delivery efficiency metrics 300 that can be utilized in accordance with various embodiments. This example shows an approach that can balance planned vehicle miles with planned vehicle hours, and use these to determine “optimal” rider miles 302 for use in determining service efficiency. The optimal miles can be prorated to planned miles that have not yet been driven. The vehicle miles metric 304 can differ from the vehicle hours metric 306 along a number of different dimensions. For example, the vehicle to service area assignment for vehicle miles can be static, while the assignment for vehicle hours can be dynamic. Further, the optimization goal for a vehicle miles-based approach can be routing efficiency, while the optimization goal for a vehicle hours-based approach can be the overall service efficiency. Another type of optimization metric is referred to herein as a “made good” metric. For vehicle miles, this can be an occupancy made good (OMG) metric, and for vehicle hours this can be a velocity made good (VMG) or similar value. These “made good” metrics can provide an indication of whether specific optimization goals are met, and a balance can be made to make sure that both metrics are balanced while satisfying that goal, in order to provide for adequate occupancy (and thus operational efficiency) with sufficient average velocity (to provide operational efficiency as well as customer service satisfaction). Different objective functions can prioritize either parameter (or a combination of the parameters) based on service goals, but can attempt to ensure that the metrics both satisfy specified service criteria.

As mentioned, a route optimization system in some embodiments can attempt to utilize such an objective function in order to determine and compare various routing options. FIG. 4 illustrates an example system 400 that can be utilized to determine and manage vehicle routing in accordance with various embodiments. In this system, various users can use applications executing on various types of computing devices 402 to submit route requests over at least one network 404 to be received by an interface layer 406 of a service provider environment 408. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a WiFi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 412 or other such location.

Information for the request can be directed to a route manager 414, such as may include code executing on one or more computing resources, configured to manage aspects of routes to be provided using various vehicles of a vehicle pool or fleet associated with the transport service. The route manager can analyze information for the request, determine available planned routes from a route data store 416 that have capacity can match the criteria of the request, and can provide one or more options back to the corresponding device 402 for selection by the potential rider.

The appropriate routes to suggest can be based upon various factors, such as proximity to the origination and destination locations of the request, availability within a determined time window, and the like. In some embodiments, an application on a client device 402 may instead present the available options from which a user can select, and the request can instead involve obtaining a seat for a specific planned route at a particular planned time. In some embodiments, a passenger ride request may be associated with one or more conditions, such the number of passengers and an amount cargo that will be brought onboard. Other conditions may include preferences such as a preference for the passenger-only vehicle, no preference regarding riding with cargo, or no preference regarding riding with cargo as long as no deliveries are made during the passenger's trip. In some embodiments, cargo deliveries may also be associated with one or more conditions, such as size, weight, number of packages, and delivery constraints. Example delivery constraints may include a time constraint (e.g., 1 hour delivery), special handling instruction such as requiring a cooler or a “fragile” designation. Thus and other factors may be taken into consideration when determining routes and assigning vehicles.

As mentioned, however, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 414 can receive several such requests, and can attempt to determine the best selection of routes to satisfy the various requests. In this example the route manager can work with a route generation module 418 that can take the inputs from the various requests and provide a set of route options that can satisfy those requests. This can include options with different numbers of vehicles, different vehicle selections or placements, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 422 can determine the cost for a specific request using pricing data and guidelines from a price repository 424, which the user can then accept or reject.

In this example, the route generation module 418 can generate a set of routing options and assigned vehicle type based on the received requests or scheduled deliveries for a specified area over a specified period of time. A route optimization module 420 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 420 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

FIG. 5 illustrates an example system 500 similar to that of FIG. 4, but which includes additional component configured to predict demand and provide for proactive vehicle movement in accordance with various embodiments. In this example, the system can include at least one demand simulation sub-system 502, device, or component, which can attempt to predict demand for a specific service area as discussed and suggested herein. The demand simulator can determine simulation parameters, such as the time of day (e.g., a fifteen minute window), a day of the week, a season, and special events or planned occurrences (e.g., construction), which can be used to run the simulation. The simulator 502 can obtain relevant data from a historical demand data repository 504, and can analyze that data using one or more predictive algorithms or processes to predict demand (and potentially other values discussed herein) for that particular time and location. As mentioned, in some embodiments machine learning or a trained model can be used instead, which can accept the time and condition input and provide predicted demand and related values accordingly.

In some embodiments the demand simulator 502 can provide the prediction information to the route generation and/or optimization components 418, 420, which can utilize this information to determine routing of vehicle based at least in part upon the predicted demand. This includes proactively moving vehicles, assigning routes and vehicles based on predicted destinations, and the like. In some embodiments this functionality can be injected into an existing system using a false request generator 506, or other such system or service, which can submit user requests corresponding to the predicted demand. This can cause the system to consider the predicted demand when making routing (and other) decisions because these requests will be treated by the system as actual requests. In this example, the route generation module 418 can generate a set of routing options based on the received and fake requests for a specified area over a specified period of time. The route generation module can also determine how to change the state of the available capacity as measured by the objective function.

In some embodiments, the false request generator 506 or other such sub-system can be configured to then cancel the ride at an appropriate time, such as when a cancelation criterion is satisfied, in order to prevent the system from attempting to deliver on the fake route. There may be various cancelation criteria utilized, such as may relate to a distance from the fake route origin location, an amount of time before the start time for the fake route, a scheduled time, or the receiving of an actual route request, among other such options. The criteria used can depend at least in part upon the type of location or amount of available capacity, and the values or thresholds for those criteria can be learned or updated dynamically over time, such as by using machine learning or other such approaches. The vehicle can be proactively placed, and then when the route is canceled the system can direct the vehicle to an appropriate, nearby location using other vehicle placement logic already utilized by the system. In some embodiments there can also be a mechanism for ensuring that actual ride requests take priority over these fake ride requests used for vehicle positioning and other such purposes. For example, a special code or identifier can be used that can cause the request to be treated as low priority, such that other requests or types of routes can take precedence. In other embodiments, the false request generator 506 or route manager 414 can monitor the actual requests, and if necessary can submit a request to cancel the fake request. Various other options can be utilized as well within the scope of the various embodiments. The routing and placement can also be monitored and updated over time, such as to account for variations in actual demand across the service area. The instructions or information sent from a fleet manager 430 to the various vehicles 434 can in many cases be the same as for actual ride requests, while in other embodiments the information may indicate that the route is for proactive placements, such that the driver can be aware that timing and other issues may not be as critical as for other types of requests.

As mentioned, the projection and analysis can be performed for a variety of different service areas, which can be quite large in size or may take a significant time to traverse due to traffic or other conditions. In some locations there may be a limited number of parking facilities available for the vehicles for a service provider, such that the proactive positioning may be at least somewhat limited to selecting the optimal parking facility based upon the predictions. In some embodiments where the facilities are far (time or distance wise) from the predicted origination location, there can be various other factors or options considered as well. These can include, for example, paid street parking, employee residence parking, continual driving for autonomous vehicles, and other such options. For options such as paid parking that involve an additional cost, that cost can be figured into the optimization and routing process. In some embodiments it may be more cost effective to not proactively position a vehicle, where the proactive positioning would involve additional cost, driver overtime, etc. Various approaches can attempt to determine a preferable end-to-end solution with a better vehicle rest location based at least in part upon the projected demand.

In various embodiments an attempt can also be made to maintain a consistency of capacity density over time. For example, in some embodiments the demand is analyzed for periods of time of specific length, such as for 15 minute intervals. Such an approach can mean that there might be four very different demand densities or distributions within a single hour. While it may be desirable to match demand to capacity density, it may not be cost effective to cause some of the vehicles to move up to four times an hour to achieve density matching. Thus, approaches can look to demand density over a period of time and attempt to place vehicles in such a way that, over an extended period of time, the density of capacity may correspond to the density of demand. For example, there might be high demand downtown near the top of the hour as people get off work, but low demand at other times. It may not be practical to move cars in and out of the area every hour based on this fluctuation in demand. Based on cost, however, it may be beneficial to move some of the vehicles from that area if it is anticipated that there will be little demand for the next 45 minutes, and there may be demand in a nearly region. These and other factors can be considered in the optimization and routing approaches, such that the proactive positioning and density matching does not result in excessive vehicle movement and additional cost. Vehicles in many embodiments will only be proactively placed where the benefit justifies the placement, as may be determined using an objective function or other process or algorithm as discussed herein that can take into account metrics such as operational efficiency. As mentioned, in at least some embodiments there may be minimum distances or benefits required before proactively moving a vehicle as well, as moving a vehicle a couple blocks based on a small fluctuation in predicted demand may not justify the action. Factors such as wear to the vehicle and risk of damage or accidents may also be considered, such that there may need to be at least a minimum amount of benefit predicted before moving any specific vehicle. Every mile that a vehicle drives unoccupied can generate additional cost.

As mentioned, the various destinations and time windows of the predicted demand can be considered as well. For example, a predicted demand on a particular block of nine people does not necessarily mean that a single van with nine available seats should be proactively positioned, as the requested routes may be significantly different and unable to practically be served by a single vehicle. Similarly, it may not be cost effective to proactively position nine different vehicles in that location. Accordingly, the proactive placement and routing can be performed based at least in part upon the predicted number of routes to be required from that location, in addition to the seat density or vehicle density used for proactive placement determinations. Thus, density matching may attempt to place the appropriate seating capacity at a location to match the demand capacity, and provide that seating capacity using an appropriate number and/or type(s) of vehicles predicted to be required for the associated route(s).

Accordingly, some approaches can attempt to reach an optimal state that corresponds to a “zero” state for a service area, where the density of capacity is equal to the density of demand for a specified period of time, the demand including both actual and predicted demand. Other approaches can attempt to reach an optimal state where vehicles are moved proactively to attempt to match capacity and demand density to the extent that such vehicle movement satisfies criteria such as those discussed elsewhere herein with respect to the objective function and other such approaches. When a vehicle is not actively serving a trip or route, for example, that vehicle can be parked at a nearby location, moved to a location of anticipated future demand, or moved to a determined intermediate location, among other such options, where in at least some embodiments the selected option corresponds to the overall selected routing solution. In some embodiments routing options for vehicles currently serving routes can also take into account the predicted demand when assigning future routes or modifying existing routes, etc.

When predicting demand, the demand can be expressed as a set of records, where each record can include any of a number of different fields. These fields can include, for example, day of the week, pick up time window, an origin location or identifier, a destination location or identifier, a number of riders, a probability of occurrence, and an average booking lead time, among other such options. In at least some embodiments it can be assumed that the demand records are independent, and predicted demand that fails to materialize will not be carried forward. Further, in at least some embodiments the actual demand in excess of the predicted demand does not reduce the future predicted demand. The predicted demand injection can be performed at the initiation of a service window, for the entire length of the window. A constrained time horizon may be considered for longer service windows in some embodiments. Retraction can be performed immediately before the lead time of the demand record preceding the time interval for which the record has been declared, among other such options. The predictive demand can also be determined stop to stop, as opposed to point to point, where the points can be any identified geographic location. In some embodiments, movement such as walking or other third party transportation may not be considered for predictive placement.

In some embodiments the objective function can be modified or developed to include various factors relating to predictive demand. These can involve new metrics, or factors that make up the various existing metrics of an objective function. For example, with respect to various rider convenience factors, the sensitivity to a time match can be reduced for proactive placement, as well as the penalty for an inability to provide specific trip options relating to proactive placement. A constant walking time can be assumed for the relative trip delay cancelation, as well as a constant length. With respect to the QoS factors, none of these may apply for a proactive placement trip corresponding to a fake route, except that a penalty for trip calculation may be retained but reduced. The service delivery efficiency factors may still all apply for a proactive placement route. Thus, proactive placements are determined and optimized based much more on operational efficiency metrics than quality of service, since there would be no active riders impacted by the service of the proactive route, unless an occurrence impacts the start of an actual planned route, etc.

FIG. 6 illustrates an example process 600 for determining routes and selecting respective vehicle types for the routes, in accordance with various embodiments. It should be understood that, for this and other processes discussed herein, there can be additional, fewer, or alternative steps, performed in similar or alternative steps, or in parallel, within the scope of the various embodiments unless otherwise stated. In this example, historical route data for a plurality of previously-requested routes can be obtained 602, in which each previously-requested route being either a passenger request or a cargo request, and associated with an origin, a destination, and a time. Thus, based at least in part upon the historical route data, predicted demand for passenger requests and cargo requests can be determined 604 for each of a plurality of future times. In some embodiments, various machine learning techniques may be used in order to generate the predicted demand for the future times. A set of proactive passenger requests and cargo requests corresponding to the predicted demand may be generated 606. The set of proactive ride requests may be submitted 608 with a set of actual passenger requests and cargo requests, to a vehicle selection and route determination system. Thus, a set of routes for the future period of time may be determined 610. The set of routes may include a combination of passenger-only routes, cargo-only routes, and routes with both passengers and cargo. The routes may be assigned 612 to certain vehicles, in which the vehicles including at least one of a cargo-only vehicle, a passenger-only vehicle, and a mixed cargo and passenger vehicle. The vehicle selected for each route may be based on the type of route. For example, a passenger-only vehicle may be assigned to a route that only includes passenger ride requests and no cargo requests. Similarly, a cargo-only vehicle may be assigned to a route that only includes cargo requests. A mixed passenger and cargo vehicle may be assigned to a route that includes both passengers and cargo. When the routes and corresponding vehicles are determined, computer-readable instructions regarding the respective assigned routes may be sent 614 to the vehicles. In some embodiments, the instructions may be sent to an onboard computing system of the vehicles, such as a built-in computing system or a portable electronic device such as smart phone or tablet. In some embodiments, the computer-readable instructions cause vehicles to proactively relocate to within a determined distance of an origin location for the respective route.

In order to determine the anticipated demand for a point in time, approaches in accordance with various embodiments can analyze historical data for requests received, routes served, and other aspects over at least a determined period of time in the past. These values can be decayed, weighted, or otherwise accounted for in such a way that more recent data has more of an impact than data from the distant past, etc. The data can also be analyzed for specific time periods or occurrences, such as days of the week, weekends, seasons, events, rush hours, and the like. For a future period of time, such as 10:00 on a Wednesday in the summer for a specific geographical region with no major events listed, the historical data can be analyzed to predict the demand across that region, as well as other values such as the available capacity, routes in progress, and the like. The historical information in at least some embodiments can also be used to train one or more machine learning models, which can then provide predicted demand for a given time period with a given set of conditions, such as may relate to events occurring at that time and the like.

As an example, the historical data for a service area (i.e., a defined geographical region) can include information about the rides requested, including origin and destination locations, for a specific time period. It can also include information associated with those requests, such as maximum numbers of stopped requested, arrival time windows, and types of vehicles or service requested, among other such request options discussed and suggested herein. It can also include information about the type of rider (human, animal, package, etc.) and the type or amount of capacity needed to accommodate that rider. The historical data can also include data for the actual demand, including which routes were actually assigned and delivered, including the individual trips or segments, as well as timing and other such information. The historical data can also include performance data, such as the timeliness, number of miles incurred, amount of time incurred, types of vehicles utilized, stop deviations, etc. The historical information can also identify any special conditions to be considered, such as accidents, construction, or event traffic, which may have impacted the potential values in order to determine whether to consider those specific values in the prediction. Historical data can be obtained from any of a number of different sources, such as past data for the particular provider, third party data, user data obtained from cell phones or other mechanisms, etc.

The data can be processed to determine, for example, a predicted amount of demand for each of a set of regions within a service area in some embodiments, or a demand distribution or other such predicted demand mapping in others. This can include information about the predicted location and number of requests, such that an attempt can be made to provide sufficient capacity for each predicted trip. As mentioned, the number of riders can be modified by a likelihood factor, such that if there is a 50% chance of two people submitting requests for a particular area then a demand value of 1.0 (or another statistically determined number) may be used for the capacity demand for that location at that time. In some embodiments this can be based upon an average demand for that location and that period as well, where fractional demand is permissible. For example, an average demand could be calculated at 2.3 people, which could case capacity for 2-3 persons to be proactively moved to (or proximate) that location in at least some embodiments. For packages, an overall capacity size as well as an anticipated individual package size can be utilized, with fractional demand further based in part upon probability of demand. As mentioned, a similar approach can be taken to anticipate the destinations for the predicted demand, which can be used to select routes, assign vehicles, and take other such actions as discussed and suggested herein.

In some embodiments, in order to determine the set of routes, one or more passenger conditions associated with a passenger request of the predicted demand is determined, in which the one or more conditions includes an amount of passenger capacity (e.g., how many passengers) and cargo capacity needed, such as for luggage, groceries, etc. Similarly, one or more cargo conditions associated with a cargo request of the predicted demand may be determined, in which the one or more conditions includes an amount of cargo capacity required. Thus, at least one of the set of routes can be determined based at least in part on the one or more passenger conditions and the one or more cargo conditions.

In some embodiments, in order to determine the set of routes, a set of potential routing solutions to serve the proactive passenger and cargo requests and actual passenger and cargo requests is determined and analyzed using an objective function to generate respective quality scores for the potential routing solutions. The objective routing function may include at least one customer convenience parameter and at least one operational efficiency parameter, as described above. At least a subset of the potential routing solutions may be processed using an optimization process to improve at least a subset of the respective quality scores. Thus, a routing solution may be selected from the set of potential routing solutions, based at least in part upon the respective quality scores, the selected routing solution indicating the set of routes and assigned vehicles. At least a subset of the potential routing solutions may be processed using an optimization process to improve at least a subset of the respective quality scores.

As mentioned, the possible vehicles to assign routes to may include mixed cargo and passenger vehicles. In some embodiments, the mixed cargo and passenger vehicles may have various fixed passenger capacity and cargo capacity (e.g., 7 passenger seats and 100 cubic feet of cargo space. Some mixed cargo and passenger vehicle may have variable capacity convertible between passenger capacity and cargo capacity. For example, such a vehicle may have a maximum passenger capacity of 10 seats, all of which may alternatively be used as or convert into cargo capacity. Thus, depending on the type of space needed for a route or over the course of a route, the space can be converted accordingly. In some embodiments, the space may be configured in an optimal fashion for a particular route and remain in that configuration for the duration of the route. In some other embodiments, the space may be configured and rearranged at various times during the route to optimize the space on the fly. For example, after a passenger is dropped off, the seat may be converted into and used as cargo capacity for picking up a nearby package. In some embodiments, such variable capacity and the ability to convert between passenger capacity and cargo capacity in taken into consideration in generated the routes and assigning vehicles.

FIG. 7 illustrates an example process 700 for determining routes and selecting respective vehicle types for the routes, in accordance with various embodiments. In this example, anticipated passenger ride requests during a future period of time may be determined 702 based at least in part on historical route data, which may include records of previously received passenger and for the region or time of day. In some embodiments, a ride request of the anticipated ride requests may be associated with one or more conditions, including a preference for a passenger-only vehicle, no preference regarding riding with cargo, or no preference regarding riding with cargo as long as no deliveries are made.

Anticipated cargo deliveries for the future period of time may be determined 704 as well. In some embodiments, each anticipated cargo delivery is associated with cargo specifications, including at least one of an origin, a destination, size, weight, number of packages, and delivery constraints. The anticipated cargo deliveries may be previously scheduled or known prior to the future time, such as a list of deliveries that need to be made, and thus represent real known deliveries that are to be made. For example, some of the anticipated cargo deliveries may be associated with the same origin or the same destination, such as a post office or shipment receiving station. In some embodiments, the origin and destination of the anticipated cargo deliveries may be different points on a route of the one or more routes. In some embodiments, the anticipated cargo deliveries may be predicted cargo deliveries rather than actual cargo delivery requests. In some embodiments, the anticipated cargo delivery may be predicted based on historical route data of previously made cargo delivery request.

One or more routes for one or more vehicles may be determined 706 based at least in part on the passenger ride requests and the cargo deliveries. The one or more vehicles may be selected from at least one cargo-only vehicle, at least one passenger-only vehicle, and at least one mixed cargo and passenger vehicle. The passenger-only vehicles may include vehicles of different passenger capacities, such as having 4 seats, 7 seats, 10 sets, etc. Similarly, the cargo-only vehicles may include vehicles of different cargo capacities. In some embodiments, the mixed cargo and passenger vehicles may have space that is convertible between passenger capacity and cargo capacity, such as to be able to adapt to demand. In some embodiments, the space may be convertible between passenger capacity and cargo capacity during a route of the one or more routes.

FIG. 8 illustrates an example computing device 800 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 800 has an outer casing 802 covering the various internal components, and a display screen 804 such as a touch screen capable of receiving user input during operation of the device. These can be additional display or output components as well, and not all computing devices will include display screens as known in the art. The device can include one or more networking or communication components 806, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 9 illustrates an example set of components that can comprise a computing device 900 such as the device described with respect to FIG. 8, as well as computing devices for other purposes such as application servers and data servers. The illustrated example device includes at least one main processor 902 for executing instructions stored in physical memory 904 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 906 for the device. Application instructions for execution by the at least one processor 902 can be stored by the data storage 906 then loaded into memory 904 as needed for operation of the device 900. The processor can also have internal memory in some embodiments for temporarily storing data and instructions for processing. The device can also support removable memory useful for sharing information with other devices. The device will also include one or more power components 910 for powering the device. The power components can include, for example, a battery compartment for powering the device using a rechargeable battery, an internal power supply, or a port for receiving external power, among other such options.

The computing device may include, or be in communication with, at least one type of display element 908, such as a touch screen, organic light emitting diode (OLED), or liquid crystal display (LCD). Some devices may include multiple display elements, as may also include LEDs, projectors, and the like. The device can include at least one communication or networking component 912, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 914 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any appropriate programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
obtaining historical route data for a plurality of previously-requested routes, each previously-requested route being either a passenger request or a cargo request, and associated with an origin, a destination, and a time;
determining, based at least in part upon the historical route data, predicted demand for passenger requests and cargo requests for each of a plurality of future times;
generating a set of proactive requests including passenger requests and cargo requests corresponding to the predicted demand;
submitting the set of proactive requests, with a set of actual passenger requests and cargo requests, to a vehicle selection and route determination system;
determining a set of routes for a future period of time;
determining available vehicle types for servicing the routes, the available vehicle types including at least one of a cargo-only vehicle, a passenger-only vehicle, and a mixed cargo and passenger vehicle;
selecting vehicles, of the available vehicle types, to service the routes; and
sending, to the vehicles, computer-readable instructions regarding the respective assigned routes.

2. The method of claim 1, wherein the computer-readable instructions cause vehicles to proactively relocate to within a determined distance of an origin location for the respective route.

3. The method of claim 1, further comprising:
determining one or more passenger conditions associated with a passenger request of the predicted demand, the one or more conditions including an amount of passenger capacity;
determining one or more cargo conditions associated with a cargo request of the predicted demand, the one or more conditions including an amount of cargo capacity; and
generating at least one of the set of routes based at least in part on the the one or more passenger conditions and the one or more cargo conditions.

4. The method of claim 1, wherein determining the set of routes for the future period of time further comprises:
determining a set of potential routing solutions to serve the proactive passenger and cargo requests and actual passenger and cargo requests;
analyzing the set of potential routing solutions using an objective function to generate respective quality scores for the potential routing solutions, the objective routing function including at least one customer convenience parameter and at least one operational efficiency parameter; processing at least a subset of the potential routing solutions using an optimization process to improve at least a subset of the respective quality scores; and
determining a selected routing solution, from the set of potential routing solutions, based at least in part upon the respective quality scores, the selected routing solution indicating the set of routes and assigned vehicles.

5. The method of claim 4, wherein determining the set of routes for the future period of time further comprises:
processing at least a subset of the potential routing solutions using an optimization process to improve at least a subset of the respective quality scores.

6. The method of claim 4, wherein the mixed cargo and passenger vehicle includes variable capacity convertible between passenger capacity and cargo capacity, and wherein the objective function generates the respective quality scores based at least in part on the variable capacity.

7. A computer-implemented method, comprising:
determining, based at least in part on historical route data, anticipated passenger ride requests during a future period of time;
determining anticipated cargo deliveries for the future period of time;
determining one or more routes based at least in part on the passenger ride requests and the cargo deliveries; and
assigning respective vehicles to the one or more routes, the one or more vehicles selected from at least one cargo-only vehicle, at least one passenger-only vehicle, and at least one mixed cargo and passenger vehicle.

8. The method of claim 7, wherein a ride request of the anticipated ride requests is associated with one or more conditions, including a preference for the passenger-only vehicle, no preference regarding riding with cargo, or no preference regarding riding with cargo as long as no deliveries are made.

9. The method of claim 7, wherein each anticipated cargo delivery is associated with cargo specifications, including at least one of an origin, a destination, size, weight, number of packages, and delivery constraints.

10. The method of claim 9, wherein at least a subset of the anticipated cargo deliveries are associated with the same origin or the same destination.

11. The method of claim 9, wherein the origin and destination are points on a route of the one or more routes.

12. The method of claim 7, wherein the anticipated cargo deliveries for the future period of time are known prior to the future period of time.

13. The method of claim 7, further comprising:
obtaining historical route data for a plurality of previous cargo deliveries, and
determine, based at least in part upon the historical route data, the anticipated cargo deliveries for the future period of time.

14. The method of claim 7, wherein the at least one passenger-only vehicle includes vehicles of different passenger capacities.

15. The method of claim 7, wherein the at least one cargo-only vehicle includes vehicles of different cargo capacities.

16. The method of claim 7, wherein at least one mixed cargo and passenger vehicle includes space convertible between passenger capacity and cargo capacity.

17. The method of claim 16, wherein the space is convertible between passenger capacity and cargo capacity during a route of the one or more routes.

18. A system, comprising:
at least one computing device processor; and
a memory device including instructions that, when executed by the at least one computing device processor, cause the system to:
obtain historical route data for a plurality of previously-requested routes, each previously-requested route being either a passenger request or a cargo request, and associated with an origin, a destination, and a time;
determine, based at least in part upon the historical route data, predicted demand for passenger requests and cargo requests for each of a plurality of future times;
generate a set of proactive ride requests for passenger requests and cargo requests corresponding to the predicted demand;
submit the set of proactive ride requests, with a set of actual ride requests, to a vehicle selection and route determination system;
determine a set of routes for a future period of time;
assign the routes to vehicles, the vehicles including at least one of a cargo-only vehicle, a passenger-only vehicle, and a cargo and passenger vehicle; and
send, to the vehicles, computer-readable instructions regarding the respective assigned routes.

19. The system of claim 18, wherein the instructions when executed further cause the system to:
determining a set of potential routing solutions to serve the proactive passenger and cargo requests and actual passenger and cargo requests;
analyzing the set of potential routing solutions using an objective function to generate respective quality scores for the potential routing solutions, the objective routing function including at least one customer convenience parameter and at least one operational efficiency parameter;
processing at least a subset of the potential routing solutions using an optimization process to improve at least a subset of the respective quality scores; and
determining a selected routing solution, from the set of potential routing solutions, based at least in part upon the respective quality scores, the selected routing solution indicating the set of routes and assigned vehicles.

20. The system of claim 19, wherein the mixed cargo and passenger vehicle includes variable capacity convertible between passenger capacity and cargo capacity, and wherein the objective function generates the respective quality scores based at least in part on the variable capacity.
